(19) United States
(12) Patent Application Publication
(10) Pub. No.: US 2009/0177379 A1
(43) Pub. Date: Jul. 9, 2009

(54) Navigation device and method

(76) Inventor: Rory Jones, Amsterdam (NL)

Correspondence Address: TOMTOM INTERNATIONAL B.V., REMBRANDTPLEIN 35, AMSTERDAM, 1017CT, NL

(21) Appl. No.: 12/007,138

(22) Filed: Jan. 7, 2008

(51) Int. Cl. G01C 21/00

(52) U.S. Cl. 701/207

(57) ABSTRACT

A method of operating a portable navigation device or navigation system is described, together with a computer program for implementing said method and a and navigation system capable of carrying out that method. The method includes the steps of providing a means by which a user can identify a specific location or location range on the surface of the earth, which may include the current location of the device or navigation system, and at least temporarily storing said location or range in memory. The method includes the steps of presenting to the user a plurality of user-selectable options each indicative of a plurality of transient phenomena, the selection of one or more of which results in the association of that or those phenomena with the identified location or range and the storage of such together therewith as primary information.

### BACKGROUND OF THE INVENTION

Portable navigation devices (PNDs) including GPS (Global Positioning System) signal reception and processing means are well known and are widely employed as in-car navigation systems. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favourite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function provided, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that

a user deviates from the previously calculated route during navigation therealong,

real-time traffic conditions dictate that an alternative route would be more expedient and the device is suitably enabled to recognize such conditions automatically, or

if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

More modern PNDs are being provided not only with the essential GPS antenna capable of receiving satellite signals, but also with a secondary mobile telecommunications antenna which effectively enables the device to become part of a mobile telecommunications network. Typically, the device may additionally be provided with an integrated or removable subscriber identity module (SIM) card on which are provided various data which are required to identify the device to the network and to encode and decode signals appropriate to that network to allow communication thereover.

It is also now known to provide PNDs and navigation systems with a further short-range wireless communication means, such as a Bluetooth® or Wi-Fi antenna which facilitates the pairing of the device with a similarly enabled other device, most commonly a mobile telecommunications handset.

Both of these technologies effectively permit a previously passive device, that is one which merely provides in-car navigation and route guidance functions based on the continuous and repeated determination of the current position of the device from the received GPS signals, to become an active device which is capable of transmitting information via a wider telecommunications network back to a centralized data processing service.

In this regard, U.S. Pat. No. 6,253,151 describes a feature whereby an end user of a navigation system that uses geographic data can easily report perceived errors or inaccuracies in the geographic data or other problems such as poor quality route calculation or guidance wirelessly. The end user uses a user interface of the navigation system to indicate the perceived error, inaccuracy, or other problem. The navigation system includes a report program that operates in response to the end user's indication. The report program collects information indicating the error, inaccuracy, or other problem and sends a report including the collected information to a geographic database developer. The geographic database developer can use the information in the report to update a geographic database.

The above system however is more concerned with ensuring that a centralized geographical or map database of a map data provider is as current and accurate as possible, as opposed to the provision of non-map related data, for example transient phenomena such as road works, temporary diversions and road closures, traffic congestion, accidents and other transient incidents or events which affect traffic flow and movement but do not ultimately represent a defect in the underlying map data.

Accordingly, it is an object of the present invention to provide a PND or navigation system, a method of operating such, and a computer program by means of which such are controlled, which provides an enhanced facility for reporting transient phenomena.

### BRIEF SUMMARY OF THE INVENTION

According to the present invention there is provided a method of operating a PND or navigation system, said method including the steps of providing a means by which a specific location or location range, being identifiable with reference to map data locally stored in the device or system and optionally being or including the current location, can be at least temporarily stored in memory, and characterized in that the method includes the further steps of presenting to the user a plurality of user-selectable options each indicative of a plurality of transient phenomena, the selection of one or more of which results in the association of that or those phenomena with the identified location or range and the storage of such together therewith as primary information, and further characterized in that the primary information is subsequently transmitted to a remote device.

Preferably, the primary information is subsequently transmitted wirelessly, although this invention encompasses the embodiment where the user of the device or system is afforded the opportunity of associating particular transient phenomena with a particular location or range at the time such phenomena occur, and storing the primary information in the device or system for later transmission to a remote device by means of a physical connection, for example to a remote PC or appropriate or suitable device by means of a USB or other cable type which connects the device or system to said PC or appropriate or suitable device.

In a preferred embodiment, the method includes the further step, after association and storage of the phenomena with the location or range, of presenting a further option to the user to record secondary descriptive information of the phenomena, such secondary information additionally being both at least temporarily associated with and stored with one of the location or range and the primary information, and subsequently transmitted wirelessly to a remote device.

Preferably the secondary information is transmitted wirelessly with the primary information at substantially the same time, or consecutively immediately thereafter.

Most preferably the secondary information is in at least one of alphanumeric and digitized audio form, the former being capable of being entered by the user through a touch sensitive screen of the device, and the latter being recorded through microphone means provided as part of the device or system.

In a preferred arrangement, the method includes the step of presenting an option to enter an audio recording mode, selection of which causes the device or system to activate the microphone and immediately commence the digitization of the audio signals received therefrom, such being streamingly stored in a digital audio file.

Most preferably, the association of the digital audio file with at least one of the primary information and the location or range forming part thereof occurs either before, during or after completion of the recording procedure.

In a preferred arrangement, the method includes the step of presenting an option to enter an alphanumeric character entry mode, selection of which causes the device or system to display a virtual keyboard on a display screen thereof and the simultaneous creation of a text file in memory which captures the alphanumeric characters entered by the user.

Most preferably, the association of the text file with at least one of the primary information and the location or range forming part thereof occurs either before, during or after creation of said text file.

Preferably, the transient phenomena are of at least one of the following types: phenomena which are likely to have an impact on current or future traffic flow and movement towards, at, and in the vicinity of the particular location or range specified, and phenomena which may be of interest to other device users whose current or future route may pass through or proximate the particular location or range specified. Preferably, in the former case, the transient phenomena are one or more of traffic congestion characteristics and/or details, accidents and details thereof, thoroughfare diversions, closures and restrictions including road works and repairs, current local weather conditions, and extraordinary vehicle identifications such those being particularly wide, heavy or slow, among others.

In further aspects of the invention, a computer program, embodied on computer readable media as required, is provided for implementing the methods described above, as is a PND and/or navigation system adapted to perform the methods described.

In an alternative aspect, the PND or navigation system may not be provided with a mobile telecommunications antenna, such being provided by a local mobile telephone or other device capable of communicating over a mobile telecommunications network. In this aspect, the PND or navigation system may be provided with a short-range wireless antenna by means of which a communication is established with the local mobile device such that the primary and secondary information is firstly transmitted to the local mobile device for subsequent transmission over the wireless telecommunications network thereby.

As will be appreciated from the above, the invention provides a means for real-time or quasi-real-time reporting of transient phenomena to a remote device or system for collation, validation, and subsequent return delivery to other appropriately enabled devices, most preferably by means of a wireless telecommunications network, said appropriately enabled devices effectively forming nodes within said network.

As an additional advantage, the facility for reporting transient phenomena provides a legally more acceptable means of communicating transient traffic, accident and thoroughfare phenomena than using a mobile telephone while driving, which in many countries is now illegal unless the vehicle has been fitted with a hands-free system. A yet further advantage is that the quality of information available to the user-base of appropriately enabled (i.e. having a mobile telecommunications capability) devices is markedly improved.

For example, if one or relatively few users report an accident at a particular location on a busy motorway at the time it occurs or very shortly thereafter, a prediction of traffic congestion may be made by the remote device to which the information is transmitted, especially if historic traffic volume levels are known for the particular time and motorway concerned. This information can be returned to the entire installed, active user base of enabled devices which can then both identify the information to the users thereof, and afford such users a far-in-advance opportunity to make appropriate route re-calculations should they so desire.

### BRIEF DESCRIPTION OF THE SEVERAL VIEWS OF THE INVENTION

The present application will be described in more detail below by using example embodiments, which will be explained with the aid of the drawings, in which:

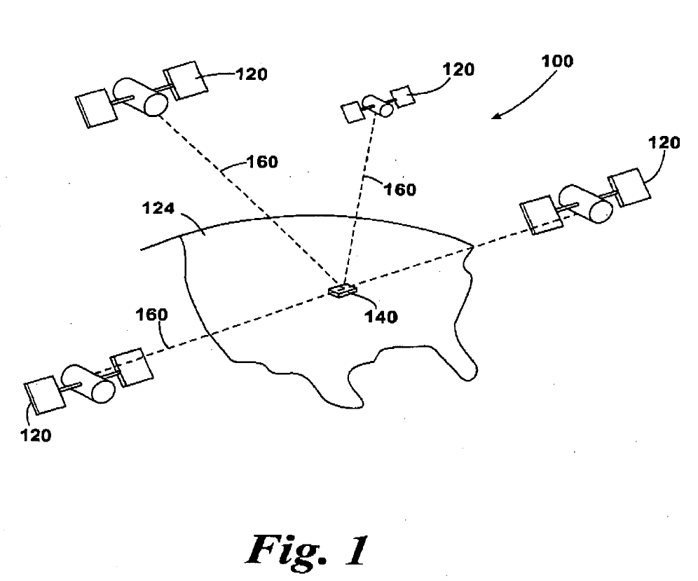

FIG. 1 illustrates an example view of a Global Positioning System (GPS);

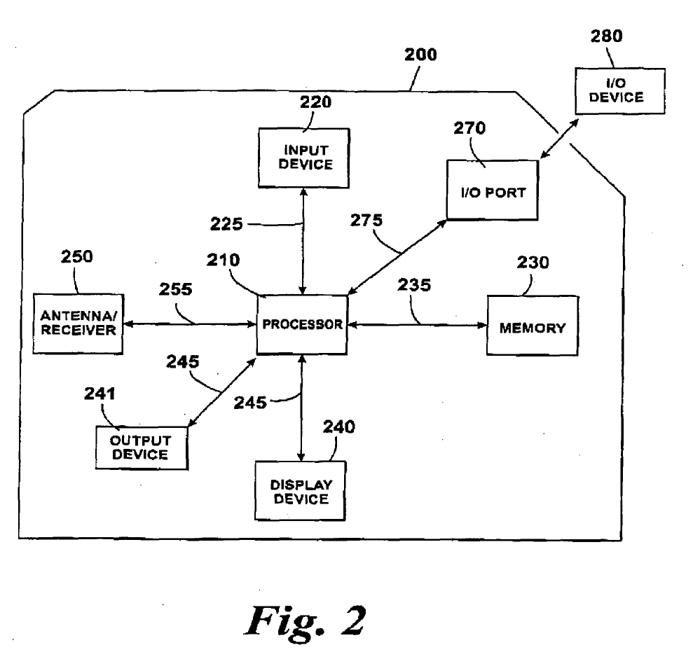

FIG. 2 illustrates an example block diagram of electronic components of a navigation device;

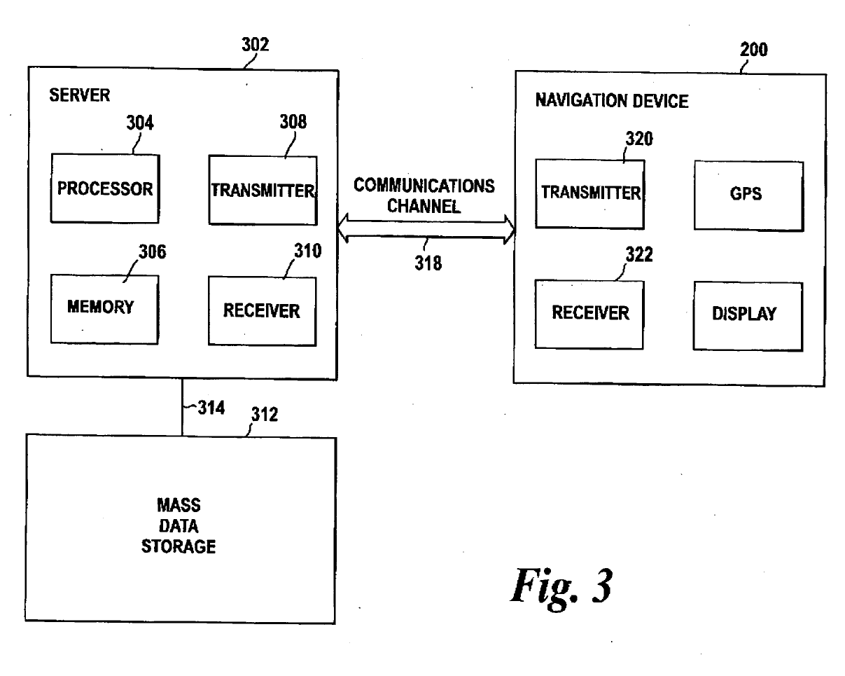

FIG. 3 illustrates an example block diagram of the manner in which a navigation device may receive information over a wireless communication channel;

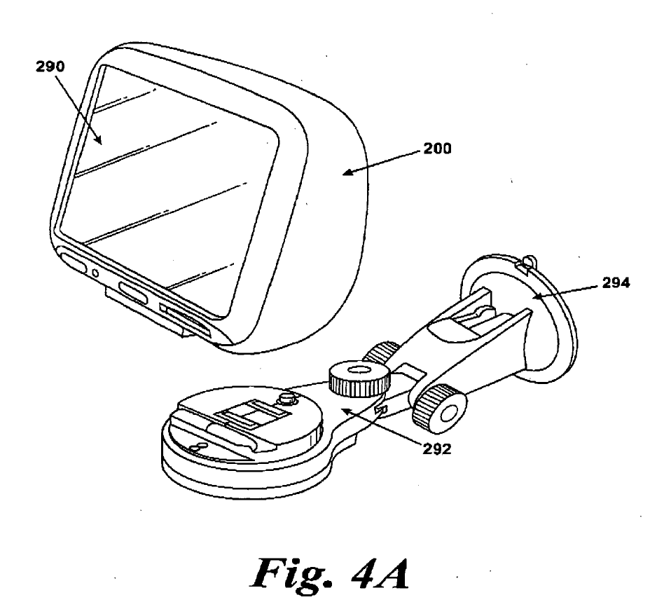

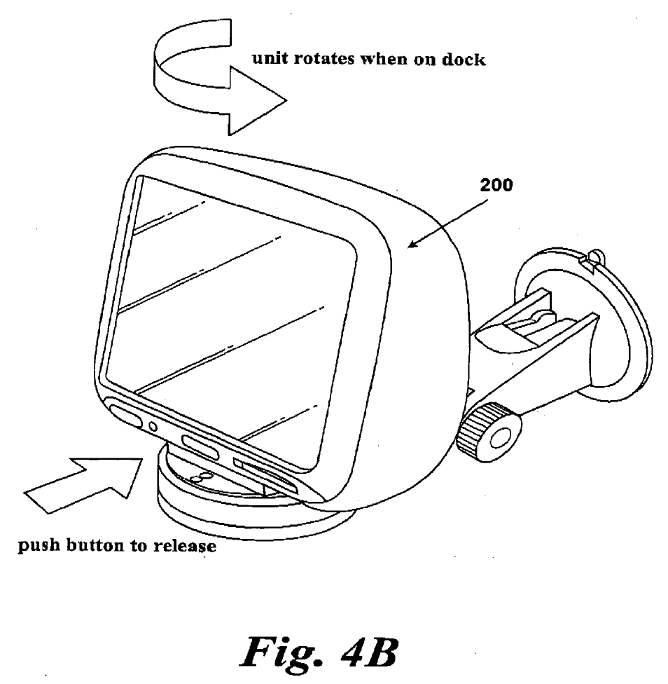

FIGS. 4A and 4B are perspective views of an implementation of an embodiment of the navigation device;

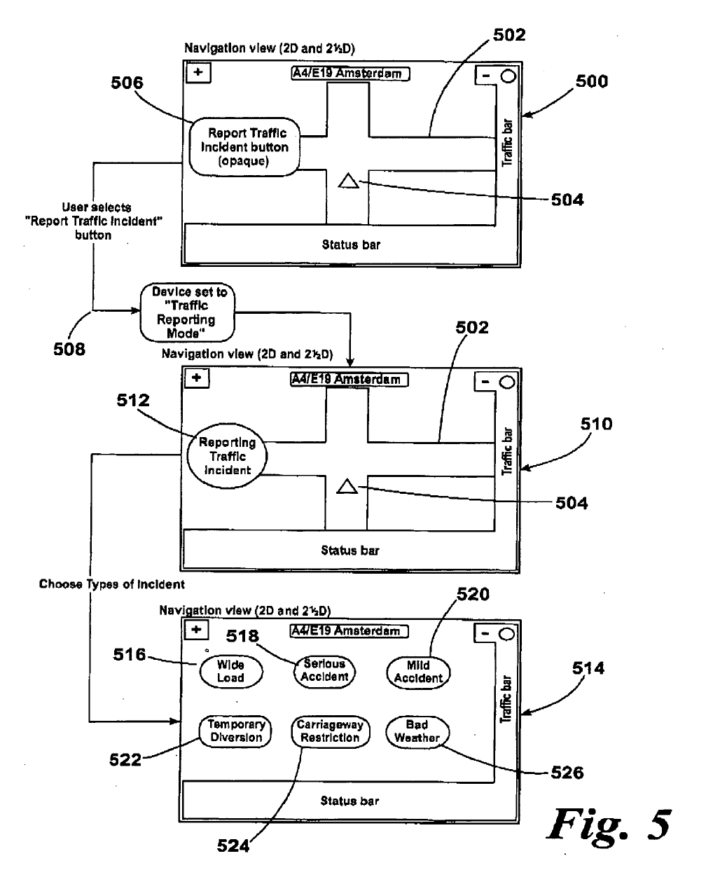

FIG. 5 shows basic screenshots from a device enabled for the present invention.

### DETAILED DESCRIPTION OF THE INVENTION

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well. In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel. The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked. As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

Referring now to FIG. 5, there are shown a set of screenshots which demonstrate one embodiment of the invention. In screenshot 500, the device is displaying map information 502 and a current location indicator 504. Additionally, a user selectable icon 506 is displayed. This is optional, and this icon may form part of an underlying menu structure composed of a variety of different icons which is accessed by merely touching the display screen during map information display, but in any event, the device provides some means whereby a user can provide an indication to the device that he wishes to report an incident or transient phenomenon of some kind. In the embodiment shown, the icon 506 relates to the reporting of a traffic incident. By selecting this on-screen icon, as indicated at 508 the device is caused to enter a traffic reporting mode.

In this mode, shown by screenshot 510, map information 502 and current location indicator 504 continue to be displayed, but an alternate, optionally user-selectable icon 512 is displayed, indicating to the user that the device is in a traffic incident reporting mode.

In this mode, the vehicle's current speed (as measured by the device) is compared to the expected traffic speed of the road network along which the device is currently travelling. This may additionally be determined by the device from a comparison of the current geographical device location and the underlying map data stored in the device memory. If the vehicle's current speed is lower than an expected traffic speed value stored in the device memory for the particular type of road concerned (alternatively this data may be derived from the map data speed limit information for the current road), the location of the vehicle and the current vehicle speed are transmitted, ideally by means of a mobile telecommunications network of which the device forms a part as a result of its being provided with a suitable antenna and an appropriate subscriber identity module, to a remote data processing server. If the vehicle's current speed is not lower than the expected traffic speed, the device exits “Traffic Incident Reporting Mode”.

While in “Traffic Incident Reporting Mode”, the device ideally wirelessly transmits its current speed and position every 30 seconds. This continues until one of the following conditions is met:

1. The vehicle speed increases to the expected traffic speed for the road for at least 30 seconds.
2. The user reaches their destination (if a route is planned).
3. The device is switched off.

When any of the above conditions is met, the device automatically exits the “Traffic Incident Reporting Mode” and the “Reporting Traffic Incident” icon 512 is replaced with the “Report Traffic Incident” icon 506.

As previously mentioned, the “Reporting Traffic Incident” icon 512 may optionally be user selectable to display further, more specific icons indicative of particular types of traffic-related, transient, local incident which might be usefully reported to the central processing centre for subsequent re-transmission to other users in the installed user-base of devices. For example, selection of icon 512 may cause display of the screenshot shown in 514, in which a number of other specific icons are displayed relating to specific types of traffic-related transient phenomena. Specifically, these are a “wide load” icon 516, a “Serious Accident” icon 518, a “Mild Accident” icon 520, a “Temporary Diversion” icon 522, a “Carriageway Restriction Icon” 524, and a “Bad Weather” Icon 526. Of course, selection of these icons may cause a return to the display of map information as shown in screenshot of 510, or may give rise to a display of a further menu structure whereby further, secondary information may be entered in the device, either alphanumerically or vocally, if the device is provided with a microphone and software enabling the recordal of the spoken word therethrough.

In the case where, after selection of one of the icons presented in screenshot 514, the device returns to the display of map information as shown in screenshot 510, an automatic storage of the particular type of transient phenomena is made within the device, depending on the icon selected.

In an alternative embodiment, it is possible that selection of the icon 506 in screenshot 500 may cause the device to immediately a screenshot including a set of icons such as those displayed at 514. In this embodiment, the device would not be caused to enter an incident reporting mode until one of the icons 516, 518, 520, 522, 524, 526 is chosen so that the particular type of transient incident, event or phenomena is suitably identified. Thereafter, the device may be caused to return to the screenshot of 510.

In a preferred embodiment, the invention may also provide a feature of automatic traffic incident reporting. Accordingly, an option will be provided as part of the device software which when selected or enabled, causes the device to periodically compare the current device speed with the expected speed of travel for the particular road network element or segment along which the device is, at the moment of comparison, traveling. The period of comparison may also be adjustable, or may be pre-set, for example at 10s intervals. If the automatic incident reporting feature is enabled, the comparison should occur regardless of whether the device is operating in a free-driving or navigation mode, that is when a route has been planned and the device is providing navigation of such route to a user.

Optionally, the automatic traffic incident reporting feature may only become “active”, after having been enabled, once the speed of the device reaches the expected travel speed of the current road network element. This is done so that incidents are not reported when the device is stationary at the beginning of a journey or immediately after having been switched on, otherwise the feature can be active as soon as the device begins to move, and spurious traffic incident data would be reported.

Whenever the current speed of the navigation device falls below 80% of the expected travel speed for the current road network element, the device shall upload some form of road element identification together with the current speed to a remote back-end processing, validation, and/or collation facility, ideally using a wireless data connection (e.g. GPRS, WiFi, 3G), as previously described.

In terms of the remote “back-end” processing facility which typically performs some collation and/or validation of the wirelessly received traffic incident information, once the information is received, the following shall ideally occur:

Traffic incident reports are converted into a unified traffic incident format

Traffic incidents shall be assigned a validity period, a default validity period being for example 30 minutes; optionally the validity period of an incident may be set according to the incident type (if one is specified) or by analysis of the incident severity (i.e. 30% speed reduction incidents have shorter validity than 80% speed reductions).

Traffic incident reports for adjacent, connecting, road network elements shall be combined into single traffic incidents,

traffic incident reports shall be delivered to the installed user base of devices as part of an overall traffic incident reporting service (optionally provided on a subscription basis to device owners), including identification of traffic incidents and general traffic flow information from other, e.g. governmental and/or commercial, sources.

1. A method of operating a portable navigation device or navigation system, the method comprising the steps of:
storing at least one of a specific location, location range and a current location into memory,
presenting to a user at least a first user-selectable option indicative of at least one reportable transient phenomenon,
associating a user-selectable option with a current or subsequent identified location or range,
storing said user-selectable option with said current or subsequent identified location or range, and
transmitting primary information to a remote device.

2. The method according to claim 1, further comprising the steps of: causing, in response to a selection of a first option, said device or system to enter a reporting mode wherein device current speed or average speed since activation of since reporting mode is periodically determined and a comparison is performed with a stored speed value appropriate to or derived for a type of road on which said device or system is currently traveling.

3. The method according to claim 2, wherein said comparison results in either an exit from said reporting mode in an event that said device speed is greater than or equal to, or within a predetermined threshold amount of a stored speed value for said type of road, or periodic creation and subsequent transmission of primary information in an event that said device speed does not meet any of these criteria.

4. The method of claim 3 wherein, when in a reporting mode, a user-selectable icon is displayed together with map information on a display of the device.

5. The method of claim 4, further comprising the steps of causing a display, in response to a selection of a user-selectable icon, of one or more further user-selectable items on a display of said device or system, said items being representative of one or more further specific types of particular transient phenomenon, selection of any one of said items causing association of information representative of that specific type of phenomenon with a location or range of locations.

6. The method according to claim 1, further comprising the steps of, after association and storage of phenomenon with location or range, presenting a further option to said user to record secondary descriptive information of said phenomenon or location or range with which such are associated, such secondary information additionally being both at least temporarily associated with and stored with one of said location or range and primary information of which it forms part, and subsequently transmitted to a remote device.

7. The method according to claim 6, further comprising the step of transmitting said secondary information wirelessly together with primary information either substantially at a same time or consecutively immediately thereafter.

8. The method according to claim 7, wherein said secondary information comprises at least one of alphanumeric and digitized audio form.

9. The method of claim 7, wherein said secondary information comprises a digitized audio form.

10. The method according to claim 9, wherein said device or system further comprises a microphone arranged to facilitate creation of said digitized audio form.

11. The method of claim 10, further comprising the step of:
presenting an audio recording mode option to said user which when selected causes said device or system to activate said microphone and commence digitization of audio signals received from said microphone; and
streamingly storing digitized audio signals in a digital audio file in a memory of the device or system.

12. The method according to claim 11, wherein said association of said digital audio file with at least one of said primary information and location or range forming part thereof occurs at least one of before, during and after completion of the recording procedure.

13. The method of claim 11, further comprising the step of presenting an alphanumeric character entry mode option to a user, selection of which causes said device or system to display a virtual keyboard on a display screen thereof and simultaneous creation and opening of a text file in memory which captures alphanumeric characters entered by said user.

14. The method of claim 13, wherein association of said text file with at least one of primary information and location or range forming part thereof occurs at least one of before, during and after creation of said text file.

15. The method according to claim 1, wherein said transient phenomena comprises at least one of: phenomena which are likely to have an impact on current or future traffic flow and movement towards, at, and in vicinity of a particular location or range specified, and phenomena which may be of interest to other device users whose current or future route may pass through or proximate said particular location or range specified.

16. The method according to claim 15, wherein said phenomena are of a type which have an impact on current or future traffic flow and movement towards, at, and in a vicinity of a particular location or range specified, said transient phenomena comprising at least one of: traffic congestion characteristics details, accidents and details thereof, thoroughfare diversions, closures and restrictions including road works and repairs, current local weather conditions, and extraordinary vehicle identifications such those being particularly wide, heavy or slow.

17. The method according claim 16, wherein said method further comprises the steps of:
displaying map information on a touch sensitive display of said device or system during a navigation or free-driving mode, and
responding to contact to said display by said device or system by displaying one or more user-selectable descriptors indicative of one or more features provided by said device, one of said features being an entering transient phenomena specific to a location or range of locations.

18. The method according to claim 1, wherein said reporting mode is an automatic traffic incident reporting mode, and said comparison occurs periodically and continuously excepting during start-up of said device or system, primary information being periodically created and automatically transmitted to a remote device when said device or system determines that its current speed does not meet one or more pre-defined criteria.

19. (canceled)

20. (canceled)
